(19) United States
(12) Patent Application Publication
(10) Pub. No.: US 2021/0090061 A1
(43) Pub. Date: Mar. 25, 2021

(54) SYSTEMS AND METHODS FOR DEVICE-PRESENT ELECTRONIC COMMERCE TRANSACTION CHECKOUT

(71) Applicant: Konnect Mobile Communications Inc., Montreal (CA)

(72) Inventor: William Lee COYLE, Montreal (CA)

(73) Assignee: Konnect Mobile Communications Inc., Montreal, QC (CA)

(21) Appl. No.: 16/954,265

(22) PCT Filed: Jan. 5, 2018
(86) PCT No.: PCT/CA2018/000005

§ 371 Date: Jun. 16, 2020

(51) Int. Cl. G06Q 20/32

(52) U.S. Cl. CPC G06Q 20/325; G06Q 20/3226; G06Q 20/3276; G06Q 20/3274

(57) ABSTRACT

It is contemplated that the present invention can provide methods and systems for executing an electronic commercial transaction over an electronic communication network including the steps of generating transaction confirmation information with a first user device in electronic communication with a second user device and a central distribution server, generating a message including at least identification information related to the second user device, directly transferring the message from the first user device to the second user device, sending the transaction confirmation information and the at least identification information to the central distribution server, validating the transaction confirmation information and the at least identification information, sending transaction execution information to the second user device, and upon acceptance of the transaction execution information, executing the electronic commercial transaction between the first user account and the second user account.

### FIELD

The present invention relates to methods and systems for facilitating electronic commerce transactions using an electronic wallet hosted on a mobile device. More specifically, the present invention relates to methods and systems for executing a device to device electronic transaction commercial between two users.

### BACKGROUND

Electronic commercial transactions have slowly supplanted cash transactions in both online and traditional “brick and mortar” commercial establishments for a variety of reasons. When a commercial transaction can be conducted electronically, the customer no longer is required to have sufficient funds on hand in the form of cash and the vendor is not required to store and maintain sufficient cash on hand to facilitate the transaction.

In the context of online transactions over the internet, electronic commercial transactions permit the vendor and the customer (or, for example, a transferor and a transferee) to be physically separated by significant distance. It will also be readily understood that a cash transaction is typically limited to single currency (or a preselected group of currencies) while an electronic transaction can theoretically be currency agnostic. Moreover, there are significant costs to the production, issuance, maintenance, transfer and storage of physical currency.

Accordingly, a number of solutions have been developed to fulfill the clear advantages that electronic commercial transactions offer participants in the modern global economy. For example, credit cards have been available for some time, which offer the ease of a cashless transaction with the outstanding balance settled between the credit card owner and the credit card issuing companies at a future date. In turn, credit card issuing companies generally charge the vendor a fee for renting/purchasing a point-of-sale (“POS”) terminal and a fee for processing the transaction, while the customer is charged interest on any outstanding balances and potentially an annual fee for use of the credit card. As such there are significant user costs associated with using a credit card in a transaction.

Electronic debit transaction systems have been developed where a customer employs an electronic access card to securely access a bank account directly through a POS terminal in a similarly cashless fashion. In this way, the funds for an electronic commercial transaction can be “debited” directly from the user's account. However, in this arrangement the vendor typically pays a rental/purchase fee for the POS terminal (to a bank or other third-party) and the user pays a transaction fee, typically collected by the bank where the account is registered.

Mobile payment systems have been developed wherein the customer can use a mobile phone as an electronic wallet in connection with a POS terminal in order to eliminate the need for an electronic access or credit card and thereby streamlining the transaction process from a user's perspective. However, from the perspective of a vendor, credit card company or a financial institution, the process remains largely the same as the traditional solutions with fees charged for interest, account access, and POS terminal purchase/rental as appropriate.

As such, given the highly advanced functionality that is possessed by modern mobile devices (such as smartphones) it would be desirable to utilize a user's mobile device in an electronic commercial transaction in order to reduce or eliminate the need for a specialized POS equipment. Moreover, there is currently no manner in which an electronic commercial transaction can be securely and directly executed between two mobile devices in close proximity to one another without the assistance of a third-party server to assist with authentication, data storage, and software hosting as necessary.

Accordingly, there is need for an electronic commercial transaction system that facilitates the execution of an electronic commercial transaction securely and directly between two mobile devices in close proximity with one another.

### BRIEF DESCRIPTION

It is contemplated that the present invention provides an electronic commercial transaction methods and systems that facilitate the execution of an electronic commercial transaction securely and directly between two mobile devices in close proximity with one another.

In at least one embodiment, it is contemplated that the present invention can provide methods and systems for executing an electronic commercial transaction over an electronic communication network including the steps of generating transaction confirmation information with a first user device having electronic access to a first user account, the first user device in electronic communication with a second user device having electronic access to a second user account and a central distribution server over the electronic communication network, generating a message with the second user device, the message including at least identification information related to the second user device, directly transferring the message from the first user device to the second user device, sending the transaction confirmation information and the at least identification information from the second user device to the central distribution server, validating the transaction confirmation information and the at least identification information, sending transaction execution information from the central distribution server to the second user device, and upon acceptance of the transaction execution information by the second user device, executing the electronic commercial transaction between the first user account and the second user account through the central distribution server.

In another embodiment, it is contemplated that the present invention can provide methods and systems for executing an electronic commercial transaction over an electronic communication network including the steps of receiving, at a central distribution server, transaction confirmation information and at least identification information from a first user device having electronic access to a first user account, the at least identification information associated with a second user device having electronic access to a second user account, the central distribution server in electronic communication with the first user device and the second user device over the electronic communication network, validating, by the central distribution server, the transaction confirmation information and the at least identification information, sending transaction execution information from the central distribution server to the second user device, and upon acceptance of the transaction execution information by the second user device, executing the electronic commercial transaction between the first user account and the second user account through the central distribution server.

### BRIEF DESCRIPTION OF THE DRAWINGS

The present invention will be better understood in connection with the following drawings, in which:

FIG. 1 is a diagram of one embodiment of an electronic communication network in accordance with the present invention;

FIG. 2 is a diagram of an embodiment of a method for executing an electronic commercial transaction over an electronic communication network in accordance with the present invention; and

FIG. 3 is a diagram of an embodiment of a method for executing an electronic commercial transaction over an electronic communication network from the perspective of a central distribution server in accordance with the present invention.

### DETAILED DESCRIPTION OF THE EMBODIMENTS

It is contemplated that the present invention provides electronic commercial transaction methods and systems that facilitate the execution of an electronic commercial transaction securely and directly between two mobile devices in close proximity with one another.

In at least one embodiment the present invention provides a method and system having a first user device and a second user device in electronic communication with a central distribution server over an electronic communication network.

It is contemplated that the present invention can be executed by way of enterprise software that is run as web-based software-as-a-service through the central distribution server, through mobile software applications loaded on user devices and as enterprise software within an organization among any other types of software arrangements or hybrid software arrangements that will be readily appreciated by the skilled person.

It is contemplated that the present invention provides a method for execution of an electronic commercial transaction securely and directly between two mobile devices in close proximity with one another over an electronic communication network.

In the context of the present invention, a suitable electronic commercial transaction can take a number of forms including, but not limited to, an electronic fund transfer from a first user to second user, an electronic payment of funds for a purchase executed between a vendor and a customer, an electronic payment of a bill between a customer and an institution, an withdrawal or deposit of funds from a financial institution and a user, an automated teller machine (ATM) withdrawal or deposit, and a multi-party electronic commerce transaction, among any other type of suitable electronic transaction between at least two parties that will be readily understood by the skilled person.

It is further contemplated that an electronic transaction can be between a first consumer user and a second consumer user (C2C), between a consumer user and a business (B2C) or between a first business and a second business (B2B), among other suitable electronic commercial transactions as required by the particular end-user application of the present invention.

In some embodiments, it is contemplated that an electronic commercial transaction can be executed wireless between remotely located user devices and commercial entity devices over an electronic communication network, or alternatively can be executed directly between user devices and commercial entity devices that are in near field communication, among other arrangements that will be readily appreciated by the skilled person.

In at least one embodiment it is contemplated that user devices can communicate electronically in close proximity by way of scanning an electronic code (such as, but not limited to, a UPC, QR or customized code) that contains encoded information necessary for facilitating the transaction.

It is further contemplated that electronic commercial transactions can take place through a variety of electronic communication network formats. For example, an electronic commercial transaction can take place through SMS, device-to-device near field communication (“NFC”), wireless application protocols (WAPs), through the internet and within a mobile application environment (including but not limited to Android®, Apple® and Blackberry® applications), among any other suitable electronic communication network format as will be readily appreciated by the skilled person.

In the context of the present invention, it is contemplated that a suitable user device can be any suitable computing device having data input capability, electronic communication network connectivity and support for the execution of an electronic commercial transaction as discussed herein. In at least one embodiment, it is contemplated that a suitable user device will be adapted to operate software in order to function as an electronic wallet.

For example, a suitable user device could include, but is not limited to, a user device such as a smartphone, a desktop computer terminal, a tablet computer, a laptop, a digital assistant, a smart TV, a wearable device and a point-of-sale device, among any other suitable user devices adapted to run software in order to function as an electronic wallet that will be readily understood by the skilled person.

As will be readily appreciated by the skilled person, a suitable user device can have, but is not limited to, input means (in the form of, for example, a touchscreen, microphone, or keyboard) wireless or hardwired connectivity (in the form of, for example, a network interface controller, a wireless network interface controller, a broadband modem, or a radio transceiver), a power source, temporary, permanent and read-write data storage and media playback capability on output means (in the form of, for example, a speaker or video screen).

Moreover, in the present context a suitable electronic communication network in accordance with the present invention is a network that permits electronic communication between suitably connected user devices. Suitable electronic communication networks could be a global wireless and hardwired network such as the internet, an internal hard-wired local area network with an institution or a private network of wirelessly connected user devices, among a wide variety of other arrangements that will be readily appreciated by the skilled person. It is contemplated that electronic communication over the network can enable secure or insecure and encrypted or unencrypted electronic communications, depending on the needs of the particular end-user application.

In the context of the present invention, a suitable central distribution server will be a computing device having electronic communication network connectivity and electronic access to physical data storage. It is contemplated that the central distribution server could be one or a number of suitable servers, and can be located in single or multiple locations, suitably connected to the user device through the electronic communication network.

It is further contemplated that the user device has electronic access to a user account hosted with the central distribution server. In the context of the present invention, a suitable user account can take a variety of forms depending on the needs of the particular end-user application. For example, in one embodiment the user account is a client account associated with the central distribution server that the user accesses through a mobile software application or application program interface. In others, the user account may in fact be an electronic account that the user accesses through a mobile software application or application program interface that is placed with a third-party institution, among other arrangements that will be readily understood by the skilled person.

It is contemplated that the user account can be a client account, an enterprise account, a third-party financial institution account, a pre-loaded cash account and a non-currency rewards account, among any other types of accounts that will be readily appreciated by the skilled person. The account can be comprised or any currency or currencies, denominations and can be comprised of monetary amounts or non-monetary amounts (such as rewards or loyalty points) as will be readily understood by the skilled person. It is contemplated that the user device has secure and encrypted communication with the associated user account however in some embodiments it is contemplated that such protections are not required, depending on the needs of the end-user application.

In some embodiments, it is contemplated that the user accesses an account through a mobile software application running on the user device while in other embodiments the user accesses an account through an application program interface with a third-party institution, among other arrangements that will be readily appreciated by the skilled person.

In at least one embodiment, it is contemplated that the user device (i.e. a device that participates in the electronic transaction) is authenticated with the central distribution server. In some embodiments, authentication can occur between the user device and the central distribution server, while in other embodiments the authentication can be performed completely by a single device, or by two or more devices in electronic communication with one another, among other arrangements that will be readily appreciated by the skilled person.

In the context of the present invention, authentication of a user device can take a variety of forms. In at least one embodiment, authentication can involve cross-referencing input authentication information provided by the user of the user device with reference authentication information stored on the central distribution server in connection with the corresponding user account. It is contemplated that authentication information can include but is not limited to a password or other alphanumeric string, personal information and a fingerprint, among any other suitable authentication information that will be readily appreciated by the skilled person. It is also contemplated that a user device may be authenticated initially and remain in a constantly authenticated state that is detected by the central distribution server as discussed in further detail below.

Once the first user device and the second user device are both authenticated it is contemplated in some embodiments that transaction confirmation information can be generated by the first (or initiating) user device. It is contemplated that transaction confirmation information can take a variety of forms and in the simplest embodiments will simply include information related to the particular transaction (including but not limited to the transaction amount information, transaction location information, transaction identification information), however other types of transaction confirmation information is contemplated including but not limited to authentication status information, device identification information, user account information, updated user information and user device geographic location among any other type of transaction confirmation information that may be required by the particular end user application under consideration.

Once the transactional process is initiated by the first (or initiating) user device, it is contemplated that the second user device can generate a message that includes, at least, identification information related to the second user device. It is contemplated, in some embodiments that the message can be encoded and can take a variety of formats, including an email, an SMS message or a text message. In some embodiments, it is contemplated that the message is a custom generated code (such as, but not limited to, an alphanumeric string or a visual QR code or barcode). Further, it is contemplated that the identification information can include any suitable identification information that can be used to verify the identification of the second user device such as but not limited to, authentication status information, device identification information and user account information, as will be readily understood by the skilled person.

Next, it is contemplated that the message can be directly transferred between the second user device and the first user device. In the context of the present invention it is contemplated that this transfer can occur in any number of suitable ways that will at least in part depend on the message format, including but not limited to sent via an email or a text message using known means. In at least one embodiment it is contemplated that the message is encoded as a QR code and the transfer between the second user device and the first user device occurs when the first user device “scans” the QR code using the camera functionality of the first user device. In this way, it is contemplated that the message (and by extension, the identification information relating to the second user device) can be directly transferred between the second user device and the first user device.

In some embodiments, it is contemplated that the first user device is a point-of-sale system and the second user device is a mobile device. In this embodiment, it is contemplated that the point-of-sale system can send the transaction confirmation information in the form of an SMS message which is in turn sent to and received by the mobile device. In response to the transaction confirmation information, a message can then be generated by the mobile device and in turn sent from the mobile device to the point-of-sale system, thereby confirming the transaction.

Once the message is received by the first user device, it is contemplated that the transaction confirmation information and at least the identification information related to the second user device can be sent to the central distribution server for validation. In the context of the present invention, validation can take any number of forms and can involve ensuring that the second user has sufficient funds in the second user account to complete the transaction, confirming that the identification information matches information that is associated with the second user account, confirming that transaction confirmation information matches the information stored in connection with either the first user account or the second user account, among any other suitable validation that will be readily appreciated by the skilled person.

Once the transaction confirmation information and the identification information is validated by the central distribution server, it is contemplated that the transaction can in turn be executed. In at least one embodiment and depending on the nature of the transaction, transaction execution information is sent to the second user device. As will be understood by the skilled person, in some transactions (such as money transfers), the transaction execution information may be sent to the first (or initiating device) while in other transactions (such as purchases) the transaction execution information will be sent to the second user device. In some transactions, both user devices may receive transaction execution information.

Once the transaction execution information is accepted, in some embodiments it is contemplated that electronic funds are transferred between the first user account and the second user account through the electronic communication network in order to complete the electronic commercial transaction. In this way, it is contemplated that the first user device and the second user device can participate in an electronic commercial transaction without requiring a specialize POS terminal.

As will be readily understood by the skilled person it is contemplated that in an electronic commercial transaction between two parties, electronic funds can be transferred in either direction depending on the nature of the transaction and moreover either (or even both) entities can be charged with an additional transaction fee (if, the query response is negative and targeted media is not displayed) depending on the specifics of the particular end user application.

In some embodiments, it is contemplated that electronic funds are transferred only between the first user account and the second user account while in other embodiments it is contemplated that funds can be transferred from the first user account (or the second user account) to the second user account (or the first user account) and, additionally, to a central distribution server account, depending on the particular arrangement of the end user application.

In this way, as will be readily understood by the skilled person, the present invention provides a method and system for facilitating the execution of an electronic commercial transaction securely and directly between two mobile devices in close proximity with one another. In this way, the transacting users can directly exchange identification information between one another in order to securely execute an electronic commercial transaction without the need for a specialized third-party point-of-sale device. In this way, a transaction fee can be transferred to the central distribution server account that is separate from the funds that are to be transferred between the user devices, as will be readily understood by the skilled person.

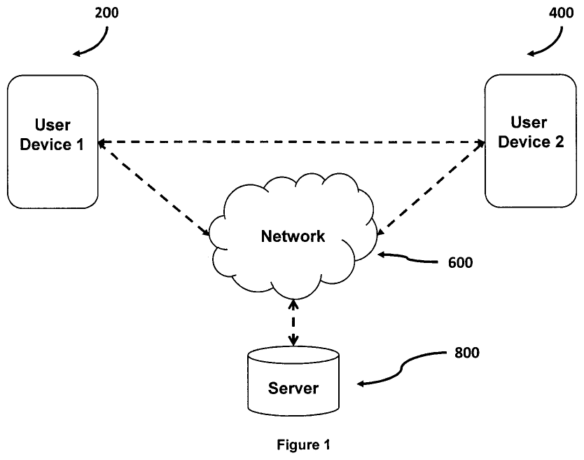

Turning to FIG. 1, at least one embodiment of a system for use in connection with the present invention is illustrated. In this embodiment, a first user device 2 is in wireless electronic communication with a second user device 4 through an electronic communication network 6. In this embodiment, user devices 2, 4 are mobile smartphone devices that are adapted to function as an electronic wallet and electronic communication network 6 is a wireless mobile communication network.

In this embodiment, user devices 2, 4 are in direct wireless electronic communication with one another and also in wireless electronic communication with a central distribution server 8 through electronic communication network 6.

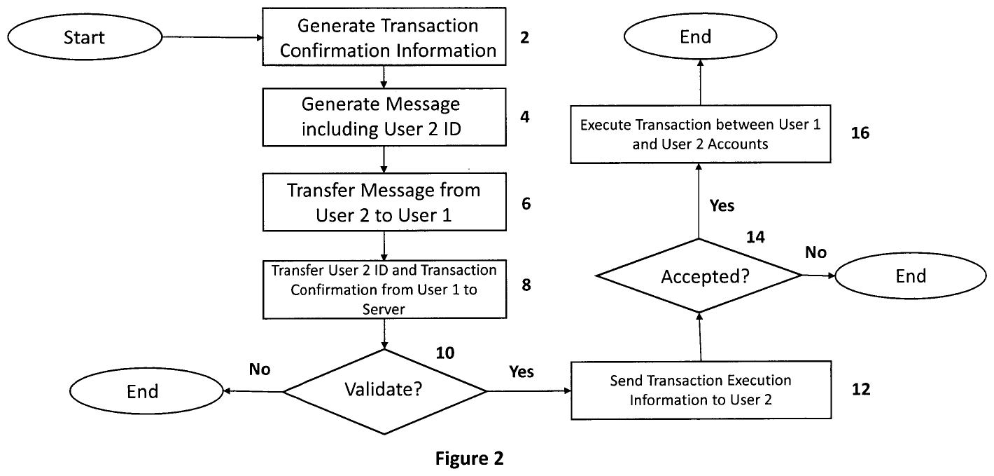

Turning to FIG. 2, at least one embodiment of a method for executing an electronic commercial transaction over an electronic communication network in connection with the present invention is illustrated. In this embodiment, the method can be initiated when the first (or initiating) user device generates transaction confirmation information 2.

As will be readily appreciated by the skilled person, it is contemplated that the present method can initiate with this step, or this step can be performed at a later stage as discussed herein. Moreover, it is contemplated that each of the first user device and the second user device can participate in an authentication step with the central distribution server over the electronic communication network or alternatively these user devices can remain in a constantly authenticated state, as will be readily understood by the skilled person.

Once the transaction confirmation information is generated 2, it is contemplated that a message can be generated by the second user device that includes identification information that is related the second user device 4. In at least one embodiment, it is contemplated that the message is a visual QR code and the identification information is information related to the second user device account, although any number of other suitable arrangements are also contemplated.

Once the message is generated 4 it is contemplated that the message can be transferred directly between the second user device and the first user device 6. In this embodiment, it is contemplated that this transfer occurs when the first user device scans the QR code, however other embodiments are contemplated where the message is transferred via Bluetooth®, NFC, email or SMS message connectivity, as will be readily understood by the skilled person.

After the first user device has received the message (which, by nature, includes the identification information related to the second user device) it is contemplated that the first user device can send the transaction confirmation information and at least the identification information related to the second user device to the central distribution server over the electronic communication network 8. Once received, it is next contemplated that the central distribution server can validate the transaction confirmation information and at least the identification information related to the second user account 10 by any known means.

For example, in this embodiment, it is contemplated that validation involves verifying the second user device identity against the second user account information (in order to confirm the second user device identity) and the transaction confirmation information is verified against second user account information (in order to confirm that the second user account contains sufficient funds to complete the contemplated transaction), however any other number of validation arrangements are also contemplated as will be readily understood by the skilled person.

If the validation step 10 fails, it is contemplated that in some embodiments the method can terminate. Alternatively, in some embodiments it is contemplated that the first user device can be prompted to alter the transaction confirmation information or to request a new message including new identification information form the second user device, among other suitable arrangements that will be readily understood by the skilled person.

If the validation step 10 is successfully completed, it is contemplated that transaction execution information is sent to the second user device 12. In this embodiment, it is contemplated that the transaction execution information includes transaction information such as but not limited to the transaction amount, the identity of the purchase and the identity of the first user device, however it is contemplated that the transaction execution information can include any suitable information relating to the proposed electronic commercial transaction between the first user and the second user.

If the transaction execution information is not accepted 14 it is contemplated that in some embodiments the method can terminate. Alternatively, in some embodiments it is contemplated that the first user device can be prompted to alter the transaction confirmation information or to request a new message including new identification information form the second user device, among other suitable arrangements that will be readily understood by the skilled person.

On the other hand, if the transaction execution information is accepted 14 it is contemplated that the central distribution server can automatically and electronically transfer the requisite funds between the first user account and the second user account in order to execute the electronic commercial transaction 16. As discussed herein, it is contemplated that the funds can be transferred between either of the first user account and the second user account to the other of the first user account and the second user account, depending on the particular end-user embodiment of the present invention. At this point it is contemplated that the method can terminate.

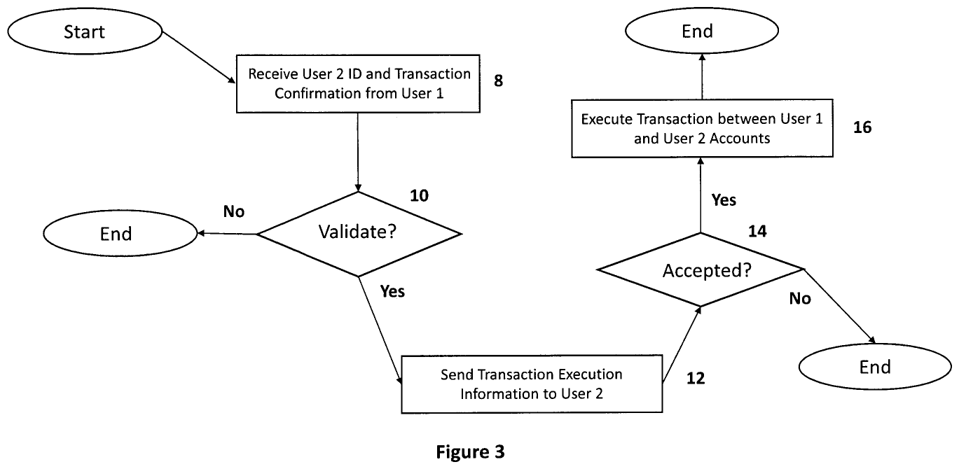

Turning to FIG. 3, another embodiment of a method for executing an electronic commercial transaction over an electronic communication network in connection with the present invention is illustrated from the perspective of a central distribution server. In this embodiment, the method can be initiated when the first (or initiating) user device sends the (previously generated) transaction confirmation information and at least the identification information related to the second user device to the central distribution server over the electronic communication network 8. Once received, it is next contemplated that the central distribution server can validate the transaction confirmation information and at least the identification information related to the second user account 10 by any known means.

For example, in this embodiment, it is contemplated that validation involves verifying the second user device identity against the second user account information (in order to confirm the second user device identity) and the transaction confirmation information is verified against second user account information (in order to confirm that the second user account contains sufficient funds to complete the contemplated transaction), however any other number of validation arrangements are also contemplated as will be readily understood by the skilled person.

If the validation step 10 fails, it is contemplated that in some embodiments the method can terminate. Alternatively, in some embodiments it is contemplated that the first user device can be prompted to alter the transaction confirmation information or to request a new message including new identification information form the second user device, among other suitable arrangements that will be readily understood by the skilled person.

If the validation step 10 is successfully completed, it is contemplated that transaction execution information is sent to the second user device 12. In this embodiment, it is contemplated that the transaction execution information includes transaction information such as but not limited to the transaction amount, the identity of the purchase and the identity of the first user device, however it is contemplated that the transaction execution information can include any suitable information relating to the proposed electronic commercial transaction between the first user and the second user.

If the transaction execution information is not accepted 14 it is contemplated that in some embodiments the method can terminate. Alternatively, in some embodiments it is contemplated that the first user device can be prompted to alter the transaction confirmation information or to request a new message including new identification information form the second user device, among other suitable arrangements that will be readily understood by the skilled person.

On the other hand, if the transaction execution information is accepted 14 it is contemplated that the central distribution server can automatically and electronically transfer the requisite funds between the first user account and the second user account in order to execute the electronic commercial transaction 16. As discussed herein, it is contemplated that the funds can be transferred between either of the first user account and the second user account to the other of the first user account and the second user account, depending on the particular end-user embodiment of the present invention. At this point it is contemplated that the method can terminate.

In this way, as will be readily understood by the skilled person, the present invention provides a method and system for facilitating the execution of an electronic commercial transaction securely and directly between two mobile devices in close proximity with one another. In this way, the transacting users can directly exchange identification information between one another in order to securely execute an electronic commercial transaction without the need for a specialized third-party point-of-sale device. In this way, a transaction fee can be transferred to the central distribution server account that is separate from the funds that are to be transferred between the user devices, as will be readily understood by the skilled person.

While the present invention has been described with reference to particular embodiments it will be apparent to anyone skilled in the art that there are many permutations and combinations of combining the primary response variables to achieve particular benefits. All such permutations and combinations are considered to be within the sphere and scope of this invention as defined in the claims appended hereto.

1. A method for executing an electronic commercial transaction over an electronic communication network comprising the steps of:
generating transaction confirmation information with a first user device having electronic access to a first user account, the first user device in electronic communication with a second user device having electronic access to a second user account and a central distribution server over the electronic communication network;
generating a message with the second user device, the message including at least identification information related to the second user device;
directly transferring the message from the first user device to the second user device;
sending the transaction confirmation information and the at least identification information from the second user device to the central distribution server;
validating the transaction confirmation information and the at least identification information;
sending transaction execution information from the central distribution server to the second user device; and
upon acceptance of the transaction execution information by the second user device, executing the electronic commercial transaction between the first user account and the second user account through the central distribution server.

2. The method of claim 1 wherein the message is encoded.

3. The method of claim 2 wherein the message is visually encoded.

4. The method of claim 3 wherein the message is a QR code, and directly transferring the message from the first user device to the second user device involves displaying the QR code on the second user device and scanning the QR code with the first user device.

5. The method of claim 1, further comprising the step of: authenticating at least one of the first user device and the second user device with the central distribution server over the electronic communication network.

6. A method for executing an electronic commercial transaction over an electronic communication network comprising the steps of:
receiving, at a central distribution server, transaction confirmation information and at least identification information from a first user device having electronic access to a first user account, the at least identification information associated with a second user device having electronic access to a second user account, the central distribution server in electronic communication with the first user device and the second user device over the electronic communication network;
validating, by the central distribution server, the transaction confirmation information and the at least identification information;
sending transaction execution information from the central distribution server to the second user device; and
upon acceptance of the transaction execution information by the second user device, executing the electronic commercial transaction between the first user account and the second user account through the central distribution server.

7. A system for executing an electronic commercial transaction over an electronic communication network comprising:
a first user device having electronic access to a first user account, a second user device having electronic access to a second user account and a central distribution server, the first user device in electronic communication with the second user device and the central distribution server over the electronic communication network, the first user device adapted to generate transaction confirmation information, the second user device adapted to generating a message, the message including at least identification information related to the second user device,
wherein the message is directly transferred from the first user device to the second user device, the transaction confirmation information and the at least identification information is sent from the second user device to the central distribution server, the transaction confirmation information and the at least identification information is validated by the central distribution server, the transaction execution information is sent from the central distribution server to the second user device, and upon acceptance of the transaction execution information by the second user device, the electronic commercial transaction is executed between the first user account and the second user account through the central distribution server.

8. A system for executing an electronic commercial transaction over an electronic communication network comprising:
a first user device having electronic access to a first user account, a second user device having electronic access to a second user account and a central distribution server, the first user device in electronic communication with the second user device and the central distribution server over the electronic communication network, the central distribution server adapted to receive transaction confirmation information and at least identification information from the first user device, the at least identification information associated with the second user device,
wherein the central distribution server validates the transaction confirmation information and the at least identification information, the transaction execution information is sent from the central distribution server to the second user device, and upon acceptance of the transaction execution information by the second user device, the electronic commercial transaction is executed between the first user account and the second user account through the central distribution server.
